(19) United States
(12) Patent Application Publication
(10) Pub. No.: US 2025/0261262 A1
(43) Pub. Date: Aug. 14, 2025

(54) HANDLING MOBILITY FAILURE IN A RADIO CELL

(71) Applicant: Lenovo (Singapore) Pte. Ltd., Singapore (SG)

(72) Inventors: Prateek Basu Mallick, Dreieich (DE); Joachim Löhr, Wiesbaden (DE); Shwetha Sreejith, Hessen (DE)

(21) Appl. No.: 19/048,380

(22) Filed: Feb. 7, 2025

Related U.S. Application Data
(60) Provisional application No. 63/551,517, filed on Feb. 8, 2024.

(51) Int. Cl. H04W 76/19; H04W 36/36; H04W 72/232

(52) U.S. Cl. CPC H04W 76/19; H04W 36/362; H04W 72/232

(57) ABSTRACT

Various aspects of the present disclosure relate to receiving, from a serving cell of a radio network, a conditional handover (CHO) configuration comprising at least one candidate radio cell and a corresponding condition for handover execution, starting a first timer in response to initiating a handover execution to a first candidate radio cell, determining that the handover execution has failed, starting a second timer in response to the handover failure, and transmitting a reestablishment request to a second candidate radio cell based on the second timer being unexpired.

### TECHNICAL FIELD

The present disclosure relates to wireless communications, and more specifically to techniques for handling mobility failure in a radio cell, for example a network energy saving (NES) cell.

### BACKGROUND

A wireless communications system may include one or multiple network communication devices, which may be known as a network equipment (NE) supporting wireless communications for one or multiple user communication devices, which may be otherwise known as user equipment (UE), or other suitable terminology. The wireless communications system may support wireless communications with one or multiple user communication devices by utilizing resources of the wireless communications system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., 5G-Advanced (5G-A), sixth generation (6G), etc.).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

A UE for wireless communication is described. The UE may be configured to, capable of, or operable to receive, from a serving cell, a conditional handover (CHO) configuration comprising at least one candidate radio cell and a corresponding condition for handover execution; start a first timer in response to initiating a handover execution to a first candidate radio cell; determine that the handover execution has failed in response to expiry of the first timer; start a second timer in response to determining that the handover execution has failed; and transmit a reestablishment request to a second candidate radio cell based on the second timer being unexpired.

A processor for wireless communication is described. The processor may be configured to, capable of, or operable to receive, from a serving cell, a CHO configuration comprising at least one candidate radio cell and a corresponding condition for handover execution; start a first timer in response to initiating a handover execution to a first candidate radio cell; determine that the handover execution has failed in response to expiry of the first timer; start a second timer in response to determining that the handover execution has failed; and transmit a reestablishment request to a second candidate radio cell based on the second timer being unexpired.

A method performed or performable by a UE for wireless communication is described. The method may include receiving, from a serving cell, a CHO configuration comprising at least one candidate radio cell and a corresponding condition for handover execution; starting a first timer in response to initiating a handover execution to a first candidate radio cell; determining that the handover execution has failed in response to expiry of the first timer; starting a second timer in response to determining that the handover execution has failed; and transmitting a reestablishment request to a second candidate radio cell based on the second timer being unexpired.

A base station for wireless communication is described. The base station may be configured to, capable of, or operable to transmit, to a UE, a CHO configuration comprising at least one candidate radio cell and a corresponding condition for handover execution; transmit a configuration for a first timer and a second timer associated with the handover execution; and broadcast assistance information associated with a set of neighboring frequencies and at least one neighbor cell.

A processor for wireless communication by a base station is described. The processor may be configured to, capable of, or operable to transmit, to a UE, a CHO configuration comprising at least one candidate radio cell and a corresponding condition for handover execution; transmit a configuration for a first timer and a second timer associated with the handover execution; and broadcast assistance information associated with a set of neighboring frequencies and at least one neighbor cell.

A method performed or performable by an anchor base station for wireless communication is described. The method may include transmitting, to a UE, a CHO configuration comprising at least one candidate radio cell and a corresponding condition for handover execution; transmitting a configuration for a first timer and a second timer associated with the handover execution; and broadcasting assistance information associated with a set of neighboring frequencies and at least one neighbor cell.

### BRIEF DESCRIPTION OF THE DRAWINGS

FIG. 1 illustrates an example of a wireless communications system in accordance with aspects of the present disclosure.

FIG. 2 illustrates an example of a protocol stack showing different protocol layers in the UE and network, in accordance with aspects of the present disclosure.

FIG. 3 illustrates an example of a timeline for conditional handover (CHO) in accordance with aspects of the present disclosure.

FIG. 4 illustrates an example of overlaying cells on different frequency layers, in accordance with aspects of the present disclosure.

FIG. 5 illustrates an example of a cell discontinuous transmission/reception configuration in accordance with aspects of the present disclosure.

FIG. 6A illustrates an example of a radio link monitoring configuration in accordance with aspects of the present disclosure.

FIG. 6B is a continuation of the radio link monitoring configuration of FIG. 6A.

FIG. 7 illustrates an example of a CHO where no triggering cell is detected in accordance with aspects of the present disclosure.

FIG. 8 illustrates another example of a CHO where no triggering cell is detected in accordance with aspects of the present disclosure.

FIG. 9 illustrates an example of a scenario for CHO in accordance with aspects of the present disclosure.

FIG. 10 illustrates an example of a UE in accordance with aspects of the present disclosure.

FIG. 11 illustrates an example of a processor in accordance with aspects of the present disclosure.

FIG. 12 illustrates an example of a NE in accordance with aspects of the present disclosure.

FIG. 13 illustrates a flowchart of a method performed by a UE in accordance with aspects of the present disclosure.

FIG. 14 illustrates a flowchart of another method performed by a UE in accordance with aspects of the present disclosure.

FIG. 15 illustrates a flowchart of a method performed by an NE in accordance with aspects of the present disclosure.

### DETAILED DESCRIPTION

The expansion of telecommunication networks has led to increased emissions and energy consumption, which adversely impact the climate. A significant contributor to network energy usage is the transmission of synchronization signal and physical broadcast channel (SS/PBCH), which are necessary for initial access to a radio access network (RAN). However, these transmission continue even when no UE is attempting to access the network (e.g., a cell), leasing to unnecessary energy consumption.

Additionally, operating expenses for telecommunication services are substantial, driven by rising mobile data traffic, increasing spectrum costs, and the need for continual investment in network infrastructure. As mobile data traffic is projected to triple in the coming years, efficient energy management in network operations has become a critical challenge.

Telecommunication networks supporting technology generations, such as 5G offer significant energy-efficiency improvements per GB compared to previous generations. However, emerging 5G use cases and the adoption of millimeter wave (mmWave) technology requires a higher density of network sites and antennas. This increased infrastructure, while enhancing network performance, also introduces the risk of higher overall energy consumption and emissions unless proactive measures are taken. Without intelligent energy management, the benefits of 5G efficiency gains may be offset by the rising energy demands of additional network components.

Furthermore, as 5G is becoming pervasive across industries and geographical areas, handling more advanced services and applications requiring very high data rates (e.g., extended reality (XR) services and applications), network deployments are becoming denser, use more antennas, larger bandwidths, and more frequency bands. The environmental impact of 5G should be managed, leading to a need to improve network energy savings.

Energy consumption has become a significant part of the telecommunication service operators' operating expenses. By some reports, the energy cost of mobile networks accounts for approximately 23% of the total operator cost. Most of the energy consumption comes from the radio access network (RAN) and in particular from the active antenna unit (AAU), with data centers and fiber transport accounting for a smaller share. The power consumption of the RAN can be split into two parts: the dynamic part which is only consumed when data transmission/reception is ongoing, and the static part which is consumed all the time to maintain the necessary operation of the radio access devices, even when the data transmission/reception is not on-going.

The Third Generation Partnership Project (3GPP) developed a network energy consumption model for the base station (e.g., gNB), including key performance indicators (KPIs) and an evaluation methodology to identify and evaluate network energy savings techniques in targeted deployment scenarios. Further study investigated how to achieve more efficient operation dynamically and/or semi-statically and finer granularity adaptation of transmissions and/or receptions in one or more network energy saving techniques in time, frequency, spatial, and power domains, with potential support/feedback from UE, potential UE assistance information, and information exchange/coordination over network interfaces.

The 3GPP study not only evaluated the potential network energy consumption gains, but also assessed and balanced the impact on network and user performance, e.g., by looking at KPIs such as spectral efficiency, capacity, user perceived throughput (UPT), latency, UE power consumption, complexity, handover performance, call drop rate, initial access performance, service level agreement (SLA) assurance related KPIs, etc.

A network expends substantial energy in transmitting synchronization signal blocks (SSBs), physical broadcast channel (PBCH) (i.e., containing the master information block (MIB) and the system information block type 1 (SIB1). In the legacy 5G network, the system information blocks (SIBs) apart from SIB1 can already be provided on demand.

However, transmission of SSB and SIB1 is useful for cell identification, idle and connected mode mobility etc. Energy consumption from constant paging transmission can be unnecessary, especially if few (or none) of the UEs being paged are actually present in a cell intending to save energy.

One of the techniques to improve network energy savings is the cell discontinuous transmission (DTX) and/or discontinuous reception (DRX) behavior, e.g., in the time domain, which may be collectively referred to as “cell DTX/DRX behavior”. The cell DTX/DRX behavior is applied at least to the UEs in a connected mode (e.g., the RRC_CONNECTED state). A periodic cell DTX/DRX cycle (i.e., comprising both active and non-active periods) can be configured by the gNB via UE-specific radio resource control (RRC) signaling per serving cell.

In a first example of cell DTX/DRX behavior during non-active periods, the gNB may turn off all transmission and reception for data traffic and reference signals (RS) during the non-active periods of the cell DTX/DRX cycle.

In a second example of cell DTX/DRX behavior during non-active periods, the gNB may turn off its transmission and reception only for data traffic during the non-active periods of the cell DTX/DRX cycle. However, in this example the gNB still transmits and/or receives RS during the non-active periods of the cell DTX/DRX cycle.

In a third example of cell DTX/DRX behavior during non-active periods, the gNB may turn off its dynamic data transmission and reception during the non-active periods of the cell DTX/DRX cycle. However, in this example the gNB may still perform transmission and/or reception associated with non-dynamic (e.g., periodic) resources, including transmission and/or reception associated with semi-persistent scheduling (SPS), configured grant on a physical uplink shared channel (CG-PUSCH), scheduling request (SR), random-access channel (RACH), and sounding reference signal (SRS) resources.

In a fourth example of cell DTX/DRX behavior during non-active periods, the gNB may only transmit RS during the non-active periods of the cell DTX/DRX cycle. For example, the gNB may transmit channel state information reference signals (CSI-RS) for measurement during the non-active periods.

In various implementations, the cell DTX/DRX behavior (also referred to as “cell DTX/DRX mode”) may be activated and/or deactivated via dynamic layer-1 (L1) or layer-2 (L2) signaling, or via UE-specific RRC signaling. Both UE-specific and common L1/L2 signaling may be used for activating/deactivating the cell DTX/DRX mode.

In some implementations, the cell DTX and cell DRX modes may be configured and operated separately (e.g., one RRC configuration set for downlink (DL) and another for uplink (UL)). In other implementations, the cell DTX and cell DRX modes can also be configured and operated together. As used here, the terms “cell DTX/DRX mode” and “cell DTX/DRX behavior” refers to the cell DTX mode/behavior, the cell DRX mode/behavior, or both cell DTX and cell DRX modes/behaviors, which may be separately or jointly configured and operated. At least the following parameters can be configured per cell DTX/DRX configuration: the periodicity, the start slot/offset, and the on-duration. Beneficially, the network may align the cell DTX and/or cell DRX modes among multiple UEs.

Another technique to improve network energy savings is by switching off the cell (referred to as “cell switch-off”). Through the implementation of cell DTX/DRX and cell switch-off, the connected mode mobility of a UE may be accomplished in the following way:

In a first aspect, the connected mode mobility may be handled mainly using a conditional handover (CHO) configuration from the network (e.g., gNB) to the UE. In some examples, the CHO configuration is communicated by higher layer signaling, e.g., using a RRCReconfiguration message containing the information element (IE) conditionalReconfiguration with a set of parameters defining conditions for handover. The UE, upon receiving the CHO configuration, does not immediately execute the handover but first monitors certain conditions configured in the IE conditional Reconfiguration. In some examples, the monitored conditions may include radio quality based measurements (e.g., measurement events A3, A4 or A5), or time- or location-based measurements (e.g., for non-terrestrial communication). Moreover, the UE only starts the handover execution upon fulfillment of all (i.e., one or more) conditions configured for a corresponding candidate cell (i.e., target cell) included in the CHO configuration.

In another aspect, the handover execution may also be conditioned on the receipt of additional signaling from the source cell, e.g., indicating that network energy saving (NES) mode (called “NES mode indication,” which is signaled using physical (PHY) layer downlink control information (DCI) format 2_9) has been turned on, thereby triggering the UEs that already found a handover target to execute handover to the handover target. However, if no specific indication is included, a UE may not know if the NES mode indication is for a cell switch-off case or for a cell entering the cell DTX and/or cell DRX mode.

In another aspect of the connected mode mobility, a UE may start to execute the (conditional) handover accordingly to a cell that fulfills all (one or more) conditions configured for a corresponding candidate (target) cell. The handover execution starts with the UE starting a timer T304. If the handover execution fails, i.e., the timer T304 expires, the UE initiates a cell selection procedure (e.g., as defined in 3GPP technical specification (TS) 38.304) which is controlled by another timer T311. If a suitable cell is found, UE stops the timer T311 and then executes a reestablishment procedure, and starts the timer T301.

However, since the source NES cell (i.e., serving cell) may continue to transmit SS/PBCH and SIB1 during the non-active periods of the cell DTX/DRX cycle (e.g., even after this cell switches off or transitions to sleep in accordance with the activated cell DTX/DRX cycle), the source NES cell may appear to the UE as the best candidate cell during the cell selection procedure. Accordingly, the UE may transmit a RRC reestablishment request to the source cell—but source cell may never respond, leading to failure of the RRC reestablishment procedure. This all expends the UE's battery and wastes time, thus adversely impacting the user experience since the total interruption time (T304+T311+T301) could take several seconds.

To further address the challenges associated with a UE's handover to a NES cell using cell DTX/DRX techniques, the present disclosure describes UE-side and network-side techniques for handling mobility failure in a NES cell. One straightforward option is to not select source NES cell in the cell selection procedure (i.e., when the timer T311 is running), to ensure that handover will not be affected by cell DTX/DRX techniques.

However, this option is sub-optimal since it may lead the UE to select another cell on the same frequency as that of the source NES cell, i.e., a non-best cell is selected for executing the RRC reestablishment procedure, starting with a physical random-access channel (PRACH) transmission. This option may also increase intra-cell and inter-cell interference and therefore adversely affect the network performance and user experience, and thus should be avoided.

In various implementations, when a NES CHO fails and timer 311 is running, a UE may make cell selection only from non-source frequency (i.e., cell selection is limited to one or more frequency layers different from the frequency layer associated with the source/serving cell). Alternatively, the UE may make cell selection from any neighboring frequency but include the source frequency (i.e., the frequency layer associated with the source/serving cell) only if the source cell is not the best radio cell on that frequency. Additionally, the UE may also consider the source cell for cell selection if it can determine that the source cell will not be sleeping at this time. The UE may determine whether the source cell will be sleeping based on an RRC configuration for cell DTX/DRX and/or based on new signaling from the network.

If a CHO to a NES cell fails and the timer 311 is running, then the UE may use a new a reestablishment cause other than ‘handover failure’ to indicate the failure. Upon receiving the new failure cause (i.e., indicating the handover failure is due to NES behavior), the network may remedy the situation in one of the following ways:

In one implementation, the network (e.g., gNB) may request the UE to perform a handover to a specific cell indicated in the handover command, referred to as a redirection request. In another implementation, the network (e.g., gNB) may send an RRC connection release message to the UE, e.g., with or without a redirection request. In a third implementation, the network (e.g., gNB) may cause the cell to exit the NES mode and thereafter the network (e.g., gNB) may inform the UE that the NES mode is deactivated.

Regarding enabling radio link management (RLM) aspects, the UE may receive a (e.g., NES) CHO configuration from the network. Accordingly, if the UE starts cell measurements but has not found a suitable target (triggering) cell satisfying the included CHO conditions for it, the source cell may enter sleep subsequently but may keep transmitting SSB. Various RLM solutions are described herein.

While presented as distinct solutions, one or more of the solutions described herein may be implemented in combination with each other. Aspects of the present disclosure are described in the context of a wireless communications system.

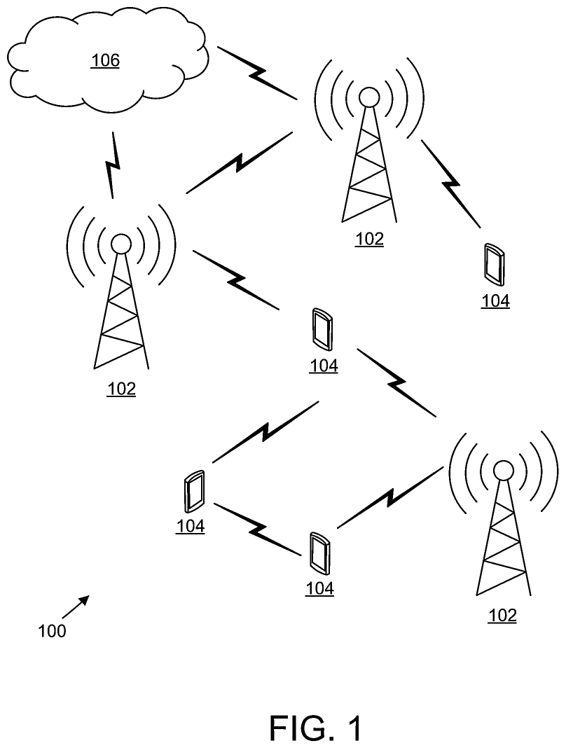

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as a Long-Term Evolution (LTE) network or an LTE-Advanced (LTE-A) network. In some other implementations, the wireless communications system 100 may be a New Radio (NR) network, such as a 5G network, a 5G-Advanced (5G-A) network, or a 5G ultrawideband (5G-UWB) network.

In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, a NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an internet-of-things (IoT) device, an internet-of-everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N3, or network interface). In some implementations, the NE 102 may communicate with each other directly. In some other implementations, the NE 102 may communicate with each other or indirectly (e.g., via the CN 106). In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N3, or another network interface). The packet data network may include an application server. In some implementations, one or more UEs 104 may communicate with the application server. A UE 104 may establish a session (e.g., a protocol data unit (PDU) session, or a PDN connection, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively.

Each slot may include a number (e.g., quantity) of symbols (e.g., orthogonal frequency domain multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHZ), FR2 (24.25 GHz-52.6 GHZ), FR3 (7.125 GHZ-24.25 GHZ), FR4 (52.6 GHz-114.25 GHZ), FR4a or FR4-1 (52.6 GHz-71 GHZ), and FR5 (114.25 GHZ-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

Wireless communication in unlicensed spectrum (also referred to as “shared spectrum”) in contrast to licensed spectrum offer some obvious cost advantages allowing communication to obviate overlaying operator's licensed spectrum and rather use license free spectrum according to local regulation in specific geographies. From the third generation partnership project (3GPP) technology perspective, the unlicensed operation can be on the Uu interface (referred to as NR-U) or also on sidelink interface (e.g., SL-U).

For initial access, a UE 104 detects a candidate cell and performs downlink (DL) synchronization. For example, the gNB (e.g., an implementations of the NE 102) may transmit a synchronization signal and broadcast channel (SS/PBCH) transmission, referred to as a synchronization signal block (SSB). The synchronization signal is a predefined data sequence known to the UE 104 (or derivable using information already stored at the UE 104) and is in a predefined location in time relative to frame/subframe boundaries, etc. The UE 104 searches for the SSB and uses the SSB to obtain DL timing information (e.g., symbol timing) for the DL synchronization. The UE 104 may also decode system information (SI) based on the SSB. Note that with beam-based communication, each DL beam may be associated with a respective SSB.

After performing DL synchronization and acquiring essential system information, such as the master information block (MIB) and the system information block type 1 (SIB1), the UE 104 performs uplink (UL) synchronization and resource request by performing a random-access procedure, referred to as “RACH procedure” by selecting and transmitting a preamble on the physical random access channel (PRACH). The PRACH preamble is transmitted during a random access channel (RACH) occasion, i.e., a predetermined set of time-frequency resources that are available for the reception of the PRACH preamble. Note that with beam-based communication, the UE 104 may select a certain DL beam and transmit the PRACH preamble on a corresponding UL beam. In such implementations, there may be a mapping between SSB and RACH occasion, allowing the network to determine which beam the UE 104 has selected.

Regarding random access, two types of RACH procedure are supported in a 3GPP wireless communication network: A) a 4-step random-access (RA) type initiated by the sending of a RACH message 1 (Msg1) and 2-step RA type with RACH message A (MsgA). Both types of RACH procedure support contention-based random access (CBRA) and contention-free random access (CFRA).

The UE 104 selects the RA type at the initiation of the RACH procedure, e.g., based on network configuration. In one example, when CFRA resources are not configured, a reference signal received power (RSRP) threshold is used by the UE 104 to select between 2-step RA type and 4-step RA type. In another example, when CFRA resources for 4-step RA type are configured, the UE 104 performs random access with 4-step RA type. In another example, when CFRA resources for 2-step RA type are configured, the UE 104 performs random access with 2-step RA type.

Note that the network does not configure CFRA resources for 4-step and 2-step RA types at the same time for a bandwidth part (BWP). Additionally, the CFRA with 2-step RA type is only supported for handover.

The Msg1 of the 4-step RA type consists of a preamble transmitted on a physical random access channel (PRACH). After the Msg1 transmission, the UE 104 monitors for a response from the network within a configured window. For CFRA, a dedicated preamble for Msg1 transmission is assigned by the network and upon receiving a random access response (RAR) from the network, the UE 104 ends the random access procedure. For CBRA, upon reception of the RAR, the UE 104 sends a RACH message 3 (Msg3) using a UL grant scheduled in the RAR and monitors for contention resolution. If contention resolution is not successful after Msg3 (re) transmission(s), then the UE 104 goes back to Msg1 transmission.

The MsgA of the 2-step RA type includes a preamble on the PRACH and a payload on a physical uplink shared channel (PUSCH). After the MsgA transmission, the UE 104 monitors for a response from the network within a configured window. For CFRA, a dedicated preamble and PUSCH resource are configured for MsgA transmission and upon receiving the network response, the UE 104 ends the random access procedure. For CBRA, if contention resolution is successful upon receiving the network response, then the UE 104 ends the random access procedure; however, if a fallback indication is received in a RACH message B (MsgB), the UE 104 performs Msg3 transmission using the UL grant scheduled in the fallback indication and monitors for contention resolution. If contention resolution is not successful after Msg3 (re) transmission(s), the UE 104 goes back to MsgA transmission.

If the random access procedure with 2-step RA type is not completed after a number of MsgA transmissions, the UE 104 can be configured to switch to CBRA with 4-step RA type.

In 3GPP NR, the gNB may transmit the maximum 64 SSBs and the maximum 64 corresponding copies of physical downlink control channel (PDCCH) and/or physical downlink shared channel (PDSCH) for delivery of SIB1 in high frequency bands (e.g., 28 GHz). This may cause significant network energy consumption even for a very low traffic load condition. According to 3GPP Technical Report (TR) 38.864 (v18.1.0), for network energy savings, on-demand SSB and/or SIB1 (SSB/SIB1) transmissions and a cell without SSB/SIB1 transmission were considered. When a cell does not transmit SSB/SIB1, for a UE 104 to access the cell, the UE 104 should obtain SI of the cell from other associated carriers/cells and synchronize from other associated carriers/cells. When a cell is in a long period of cell inactivity, a UE 104 served by the cell can trigger SSB/SIB1 transmissions by sending a request to the cell.

According to implementations of the present disclosure, one or more of the NEs 102 and the UEs 104 are operable to implement various aspects of the techniques described with reference to the present disclosure.

In some implementations, a NE 102 may transmit, and a UE 104 may receive, a CHO configuration comprising at least one candidate radio cell and a corresponding condition for handover execution. In certain implementations, the NE 102 may transmit a configuration for a first timer and a second timer associated with the handover execution. In certain implementations, the NE 102 may broadcast assistance information associated with a set of neighboring frequencies and at least one neighbor cell.

In response to initiating a handover execution to a first candidate radio cell, the UE 104 may start the first timer and may further determine that the handover execution has failed in response to expiry of the first timer. The UE 104 may initiate the second timer in response to determining that the handover execution has failed and may further transmit a reestablishment request to a NE 102 associated with a second candidate radio cell based on the cell reselection conditions being satisfied before the second timer expires.

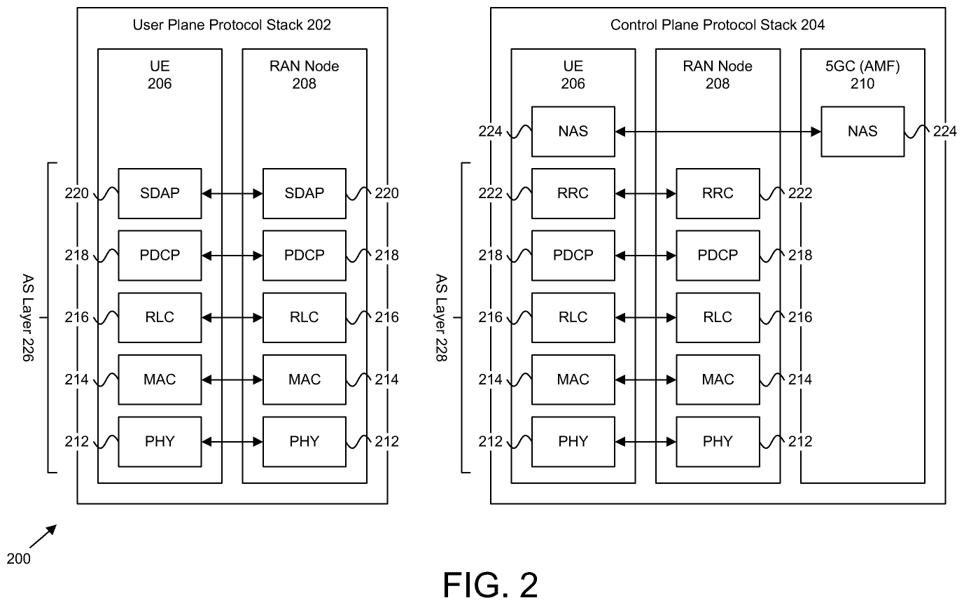

FIG. 2 illustrates an example of a protocol stack 200, in accordance with aspects of the present disclosure. While FIG. 2 shows a UE 206, a RAN node 208, and a 5G core network (5GC) 210 (e.g., comprising at least an AMF), these are representative of a set of UEs 104 interacting with an NE 102 (e.g., base station) and a CN 106. As depicted, the protocol stack 200 comprises a user plane protocol stack 202 and a control plane protocol stack 204. The user plane protocol stack 202 includes a PHY layer 212, a medium access control (MAC) sublayer 214, a radio link control (RLC) sublayer 216, a packet data convergence protocol (PDCP) sublayer 218, and a service data adaptation protocol (SDAP) layer 220. The control plane protocol stack 204 includes a PHY layer 212, a MAC sublayer 214, an RLC sublayer 216, and a PDCP sublayer 218. The control plane protocol stack 204 also includes a radio resource control (RRC) layer 222 and a non-access stratum (NAS) layer 224.

The access stratum (AS) layer 226 (also referred to as “AS protocol stack”) for the user plane protocol stack 202 consists of at least SDAP, PDCP, RLC and MAC sublayers, and the physical layer. The AS layer 228 for the control plane protocol stack 204 consists of at least RRC, PDCP, RLC and MAC sublayers, and the physical layer. The layer-1 (L1) includes the PHY layer 212. The layer-2 (L2) is split into the SDAP layer 220, PDCP sublayer 218, RLC sublayer 216, and MAC sublayer 214. The layer-3 (L3) includes the RRC layer 222 and the NAS layer 224 for the control plane and includes, e.g., an internet protocol (IP) layer and/or PDU Layer (not depicted) for the user plane. L1 and L2 are referred to as “lower layers,” while L3 and above (e.g., transport layer, application layer) are referred to as “higher layers” or “upper layers.”

The PHY layer 212 offers transport channels to the MAC sublayer 214. The PHY layer 212 may perform a beam failure detection procedure using energy detection thresholds, as described herein. In certain implementations, the PHY layer 212 may send an indication of beam failure to a MAC entity at the MAC sublayer 214. The MAC sublayer 214 offers logical channels to the RLC sublayer 216. The RLC sublayer 216 offers RLC channels to the PDCP sublayer 218. The PDCP sublayer 218 offers radio bearers to the SDAP sublayer 220 and/or RRC layer 222. The SDAP sublayer 220 offers QoS flows to the core network (e.g., 5GC). The RRC layer 222 provides for the addition, modification, and release of carrier aggregation and/or dual connectivity. The RRC layer 222 also manages the establishment, configuration, maintenance, and release of signaling radio bearers (SRBs) and data radio bearers (DRBs).

The NAS layer 224 is between the UE 206 and an AMF in the 5GC 210. NAS messages are passed transparently through the RAN. The NAS layer 224 is used to manage the establishment of communication sessions and for maintaining continuous communications with the UE 206 as it moves between different cells of the RAN. In contrast, the AS layers 226 and 228 are between the UE 206 and the RAN (i.e., RAN node 208) and carry information over the wireless portion of the network. While not depicted in FIG. 2, the IP layer exists above the NAS layer 224, a transport layer exists above the IP layer, and an application layer exists above the transport layer.

The MAC sublayer 214 is the lowest sublayer in the L2 architecture of the NR protocol stack. Its connection to the PHY layer 212 below is through transport channels, and the connection to the RLC sublayer 216 above is through logical channels. The MAC sublayer 214 therefore performs multiplexing and demultiplexing between logical channels and transport channels: the MAC sublayer 214 in the transmitting side constructs MAC PDUs (also known as transport blocks (TBs)) from MAC service data units (SDUs) received through logical channels, and the MAC sublayer 214 in the receiving side recovers MAC SDUs from MAC PDUs received through transport channels.

The MAC sublayer 214 provides a data transfer service for the RLC sublayer 216 through logical channels, which are either control logical channels which carry control data (e.g., RRC signaling) or traffic logical channels which carry user plane data. On the other hand, the data from the MAC sublayer 214 is exchanged with the PHY layer 212 through transport channels, which are classified as UL or downlink (DL). Data is multiplexed into transport channels depending on how it is transmitted over the air.

The PHY layer 212 is responsible for the actual transmission of data and control information via the air interface, i.e., the PHY layer 212 carries all information from the MAC transport channels over the air interface on the transmission side. Some of the important functions performed by the PHY layer 212 include coding and modulation, link adaptation (e.g., adaptive modulation and coding (AMC)), power control, cell search and random access (for initial synchronization and handover purposes) and other measurements (inside the 3GPP system (i.e., NR and/or LTE system) and between systems) for the RRC layer 222. The PHY layer 212 performs transmissions based on transmission parameters, such as the modulation scheme, the coding rate (i.e., the modulation and coding scheme (MCS)), the number of physical resource blocks (PRBs), etc.

In some implementations, the protocol stack 200 may be a NR protocol stack used in a 5G NR system. Note that an LTE protocol stack comprises similar structure to the protocol stack 200, with the differences that the LTE protocol stack lacks the SDAP sublayer 220 in the AS layer 226, that an EPC replaces the 5GC 210, and that the NAS layer 224 is between the UE 206 and an MME in the EPC. Also note that the present disclosure distinguishes between a protocol layer (such as the aforementioned PHY layer 212, MAC sublayer 214, RLC sublayer 216, PDCP sublayer 218, SDAP layer 220, RRC layer 222 and NAS layer 224) and a transmission layer in multiple-input multiple-output (MIMO) communication (also referred to as a “MIMO layer” or a “data stream”).

Regarding RRC states, 3GPP defines three different RRC states/modes for 5G NR: RRC_IDLE, RRC_INACTIVE, and RRC_CONNECTED. Initially, i.e., upon powering up, the UE is in an idle mode corresponding to the RRC_IDLE state. Before performing data transfer (including placing calls), the UE must establish a connection with the network which is done using initial access via RRC connection establishment procedure. Once RRC connection is established, the UE is in a connected mode corresponding to the RRC_CONNECTED state. The RRC connection may be suspended due to inactivity, wherein the UE transitions to an inactive mode corresponding to the RRC_INACTIVE state. Via the RRC release procedure, the RRC connection is released and the UE transitions to the RRC_IDLE state.

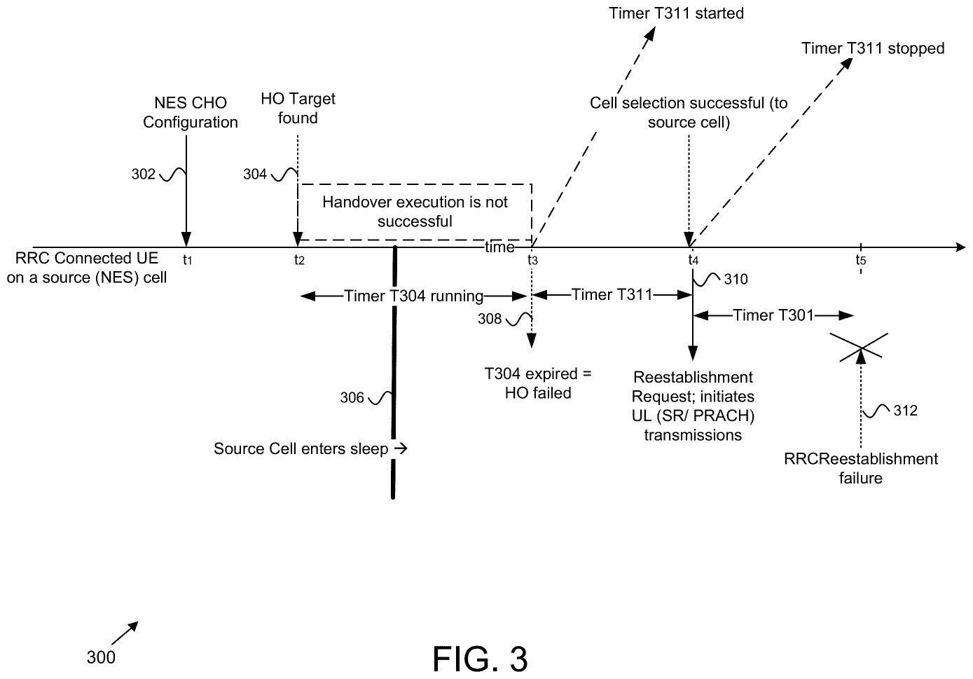

FIG. 3 illustrates an example of a timeline 300 for the CHO of a UE in a connected mode (e.g., in the RRC_CONNECTED state) on a source primary cell (PCell) that is a NES cell (e.g., a cell implementing cell DTX/DRX), in accordance with aspects of the disclosure. The timeline 300 may implement or be implemented by aspects of the wireless communications system 100, or may implement or be implemented by aspects of the protocol stack 200. For example, the timeline 300 may be implemented between a gNB, which may be examples of a NE 102 and/or a RAN node 208 as described herein, and a UE, which may be examples of the UE 104 and/or UE 206.

As depicted in FIG. 3, at a first time (t₁) the UE receives the CHO configuration, which may include an NES mode indication as well as legacy CHO configuration parameters (see event 302). The UE starts measurements and evaluation (e.g., immediately upon receipt of the CHO configuration) and at a second time (t₂) is ready to execute handover accordingly to a triggering cell that fulfills all (one or more) conditions configured for a corresponding candidate (target) cell (see event 304).

The handover execution starts by the UE starting the timer T304. The timer T304 is a supervisory timer for the handover. The value of T304 timer may be network-configured or specified, e.g., using a value of 50 ms, 100 ms, 150 ms, 200 ms, 500 ms, 1000 ms, or 2000 ms. Moreover, it is assumed that after the handover execution is started, but before the handover can succeed, the source NES cell (i.e., serving PCell) may enter a sleep mode (e.g., the inactive period of a cell DTX/DRX cycle) (see event 306).

At a third time (t₃), the UE determines that the handover execution fails, i.e., due to expiration of the timer T304 prior to handover completion (see event 308). Thereafter, the UE may perform the following actions: 1) the UE may release contention free random-access (CFRA) resources; 2) the UE may revert back to a UE configuration used in the source NES cell (i.e., serving PCell); and 3) the UE may initiate a cell selection procedure which is controlled by another timer T311. Accordingly, the UE starts the timer T311. If a suitable cell is found before the timer T311 expires at a fourth time (t₄), then the UE stops the timer T311 and executes a reestablishment procedure (e.g., the RRC connection reestablishment procedure), and starts the timer T301 (see event 310).

The timer T301 and the timer T311 are related to the RRC connection reestablishment procedure. Conventionally, the timer T311 would be started by the UE upon performing cell selection for initiating the RRC connection reestablishment and would be stopped upon selection of a suitable cell. Conventionally, the timer T301 would be started by the UE upon transmitting the RRC connection reestablishment request and would be stopped upon receiving a RRC connection reestablishment response, such as the RRCReestablishment or RRCSetup message. Alternatively, the timer T301 may be stopped by the UE upon determining that the selected cell becomes unsuitable.

With reference to FIG. 3, since the source NES cell (i.e., PCell) may continue to transmit synchronization signals (e.g., SS/PBCH) and the SIB1 (i.e., until this cell becomes switched off or transitions to sleep mode, e.g., due to activated cell DTX/DRX), the source cell may appear as the best candidate during cell selection procedure initiated when the timer T304 expires. Thus, the UE may transmit a RRC reestablishment request message to the source cell, which can lead to one of the following: 1) the UE makes contention-based PRACH transmissions (since UE previously released any contention free PRACH resources at T304 expiry); 2) the UE performs SR transmissions, if SR resources are configured; and/or 3) the UE uses configured grant (CG) resources (i.e., semi-persistently allocated UL resources) to transmit the RRC reestablishment request message.

The above transmission may be in vain, as the source NES cell (i.e., serving cell) may never respond if it has already entered the sleep mode, as shown in FIG. 3, leading to not only failure of the reestablishment procedure at a fifth time (t₁), e.g., due to expiry of the timer T301 (see event 312), but also unnecessary battery consumption in the UE, e.g., due to making the maximum allowed PRACH transmission with power ramping. This all expends UE's battery and wastes time-impacting adversely user experience since the total interruption time (T304+T311+T301) could run in seconds. Moreover, upon expiry of the timer T301, the UE may perform the remedial actions including transitioning to an idle mode (e.g., the RRC_IDLE state) as specified in 3GPP TS 38.331, with release cause ‘RRC connection failure’.

Moreover, the NES source cell may receive the PRACH Msg1 and allocate resources for Msg3 transmission but will only respond to RRC connection request messages including an establishment cause of ‘emergency’ etc. but to not an RRC reestablishment request message.

Techniques are disclosed herein to for handling mobility/handover failure in a (NES cell by considering- or ignoring-certain cells and/or frequencies during cell selection/reselection associated with a handover from a source NES cell.

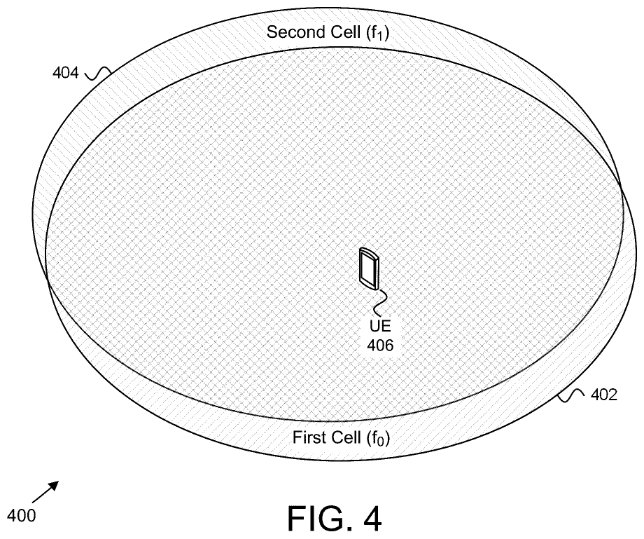

FIG. 4 illustrates an example of a RAN deployment 400 of two overlaying cells operating on different frequency layers, in accordance with aspects of the disclosure. The RAN deployment 400 comprises a first cell 402 which operates on a first frequency layer (e.g., corresponding to frequency f₀) and a second cell 404 which operates on a second frequency layer (e.g., corresponding to frequency f₁).

Consider the scenario where the first cell 402 (i.e., located on frequency f₀) is the current source cell (C₀) of the UE 406 and the second cell 404 (i.e., located on frequency f₁) a potential candidate neighbor cell (C₁). Assume that the UE 406 has intra-frequency neighbors on f₀ (e.g., cell C₂) and some inter-frequency neighbors on f₁ (say C₃), which are not shown in FIG. 4.

In a first solution, when the timer T311 is running, the UE does not consider the frequency of the source cell (f₀) for cell selection procedure if handover execution was initiated due to fulfillment of NES CHO conditions. In other words, the UE ignores the frequency layer f₀ for purposes of cell selection in the aforementioned circumstances.

In a second solution, when the timer T311 is running, the UE does not consider the frequency of the source cell (f₀) for cell selection procedure if handover execution was initiated due to fulfillment of NES CHO conditions and after receiving a PHY layer signaling (e.g., DCI) triggering handover execution in the UE. In other words, the UE ignores the frequency layer f₀ for purposes of cell selection in the aforementioned circumstances.

In a third solution, when the timer T311 is running, the UE does not consider the frequency of the source cell (f₀) for cell selection procedure if handover execution was initiated due to fulfillment of NES CHO conditions and handover execution is being triggered due to the source cell switching off. In other words, the UE ignores the frequency layer f₀ for purposes of cell selection in the aforementioned circumstances.

Here, the source cell (i.e., serving cell) may explicitly inform the UE (e.g., using RRC signaling or a PHY layer DCI) that the source cell will be switching off subsequently, with or without mentioning a start time for cell sleep. However, if a start time for cell sleep is mentioned, the UE can select the source cell frequency (f₀) as well for cell selection purpose, provided that at this point, the source cell is not sleeping and therefore should be able to respond to UE's reestablishment request.

In a fourth solution, when the timer T311 is running, the UE does not consider the frequency of the source cell (f₀) for cell selection procedure if handover execution was initiated due to fulfillment of NES CHO conditions and handover execution is being triggered due to the source cell entering cell DTX/DRX sleep. In other words, the UE ignores the frequency layer f₀ for purposes of cell selection in the aforementioned circumstances.

Here, the source cell may provide a cell DTX/DRX configuration to the UE using RRC signaling and activate the same using RRC signaling and/or PHY layer signaling (e.g., DCI) indicating that the source cell will be entering cell DTX/DRX sleep. Based on the received cell DTX/DRX configuration, UE may determine the start time for cell sleep. When this is determined, the UE can select the source cell frequency (f₀) as well for cell selection purposes, provided that at this point, the cell is not sleeping and therefore should be able to respond to UE's reestablishment request.

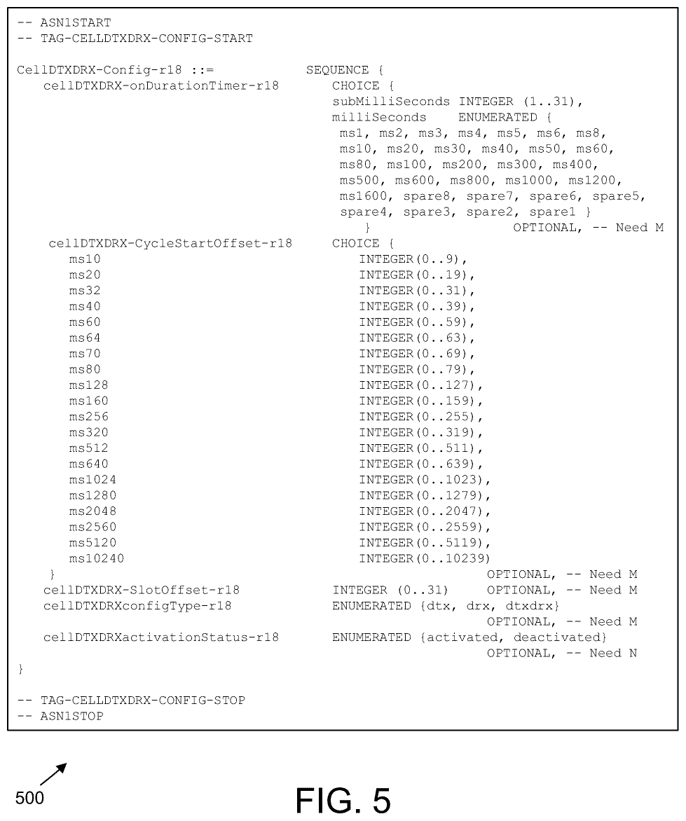

FIG. 5 illustrates an example of an Abstract Syntax Notation One (ASN.1) representation of the CellDTXDRX-Config IE 500 for configuration of cell DTX/DRX, in accordance with aspects of the present disclosure. The CellDTXDRX-Config IE 500 is used to configure cell DTX/DRX related parameters; cell DTX is configured only when C-DRX is configured.

Table 1 describes various fields for the CellDTXDRX-Config IE 500.

TABLE 1
CellDTXDRX-Config field descriptions

cellDTXDRX-CycleStartOffset
cellDTXDRX-Cycle in ms and cellDTXDRX-StartOffset in multiples of 1 ms.
The configured cellDTXDRX-Cycle is an integer multiple of configured drx-longCycle or vice
versa.
cellDTXDRX-onDurationTimer
Value in multiples of 1/32 ms (subMilliSeconds) or in ms (milliSecond). For the latter, value ms1
corresponds to 1 ms, value ms2 corresponds to 2 ms, and so on.
cellDTXDRX-SlotOffset
Value in 1/32 ms. Value 0 corresponds to 0 ms, value 1 corresponds to 1/32 ms, value 2
corresponds to 2/32 ms, and so on.
cellDTXDRXactivationStatus
Initial activation status of cell DTX/DRX indicating whether the UE shall activate the
configuration according to the received parameters. This field is only used upon the setup of a cell
DTX/DRX configuration.
cellDTXDRXconfigType
Indicates whether the configuration is for cell DTX only, cell DRX only, or joint cell DTX/DRX
configuration.

In a fifth solution, the UE may also select the source cell frequency (f₀) as well for cell selection purpose, provided that the source cell is not the best radio cell on that frequency. When this is not the case, i.e., when the source cell is the best radio cell on that frequency, the UE uses/considers only neighboring frequencies for the cell selection purpose while timer T311 is running.

In a sixth solution, the UE may select a source cell or any cell which may be saving energy i.e., has entered an NES mode. Basically, the UE does not need to analyze the NES state in the cell selection process. The selected cell, if it is an NES cell, monitors the configured PRACH resources and provides resources for the UE (in Msg2) for transmitting a Msg3. The UE may use this Msg3 resource to transmit a reestablishment request, e.g., a RRC reestablishment request message. Upon receiving the reestablishment request including a reestablishment cause as ‘handover failure,’ the network may perform one of the following actions:

In one implementation, the NES cell may request the UE to perform a handover to an included cell in the handover command. In another implementation, the NES cell may send an RRC connection release message to the UE, with or without a redirection. In another implementation, the NES cell may be instructed to come out of the NES mode and inform the UE that the NES mode is deactivated.

In one variation of the above, a new reestablishment cause other than ‘handover failure’ can be used in the reestablishment request to indicate to the network that the handover failure may be associated with an NES cell.

Aspects of a seventh solution consider a different scenario than the previous solutions. Here, is it assumed that the UE receives a CHO configuration from the network (i.e., from an NES cell), and starts measurements but has not found a suitable target (triggering) cell satisfying the included CHO conditions for it. The cell indicates a NES mode triggering to the UE using PHY layer signaling (e.g., DCI) and soon after starts sleeping.

Moreover, it is assumed that the cell keeps transmitting the SS/PBCH and so, a UE performing radio link monitoring will not observe a radio link failure (RLF) situation since the Hypothetical Block Error Rate (BLER) never drops down say beyond 10% required for the physical layer to typically send an ‘Out of Sync’ indication to upper layers. However, if the parameter csi-RS was configured by the source for the UE's radio link monitoring, then the UE will trigger RLM when the channel state information reference signals (CSI-RS) are no longer transmitted, i.e., after the cell has switched off.

If an RLF situation is not triggered due to radio link monitoring, the same may be triggered due to continuous automatic repeat request (ARQ) and/or hybrid ARQ (HARQ) and/or PRACH transmission failures, which may negatively impact the UE power consumption and battery level.

According to the seventh solution, one of the following actions may be taken to avoid the above situation:

In one implementation of the seventh solution, the network (e.g., gNB) may always configure the CSI-RS as the reference signal resource for radio link monitoring purpose to the UE and when going to sleep (e.g., due to NES mode activation using cell DTX/DRX or cell switch off), the CSI-RS will still be transmitted for a transitioning time, e.g., for at least the next 200 ms.

In another implementation of the seventh solution, when the UE receives the NES mode indication set to ‘enabled’ in PHY layer signaling (e.g., DCI), it will choose the best candidate cell as triggering cell for executing handover, if there is no cell fulfilling the NES CHO condition(s).

In another implementation of the seventh solution, when the UE receives the NES mode indication set to ‘enabled’ in PHY layer signaling (e.g., DCI), and if there is no cell fulfilling the NES CHO condition(s), the UE will inform the network that the NES CHO condition(s) are unfulfilled, e.g., using an UL transmission.

In one aspect, upon receiving the UL transmission, the network (e.g., gNB) may ask the UE to perform a handover to an included cell in the handover command.

In another aspect, upon receiving the UL transmission, the network (e.g., gNB) may send a RRC Connection release message to the UE, with or without a redirection.

In yet another aspect, upon receiving the UL transmission, the network (e.g., gNB) does not enter the NES mode and informs the UE that the NES mode is deactivated.

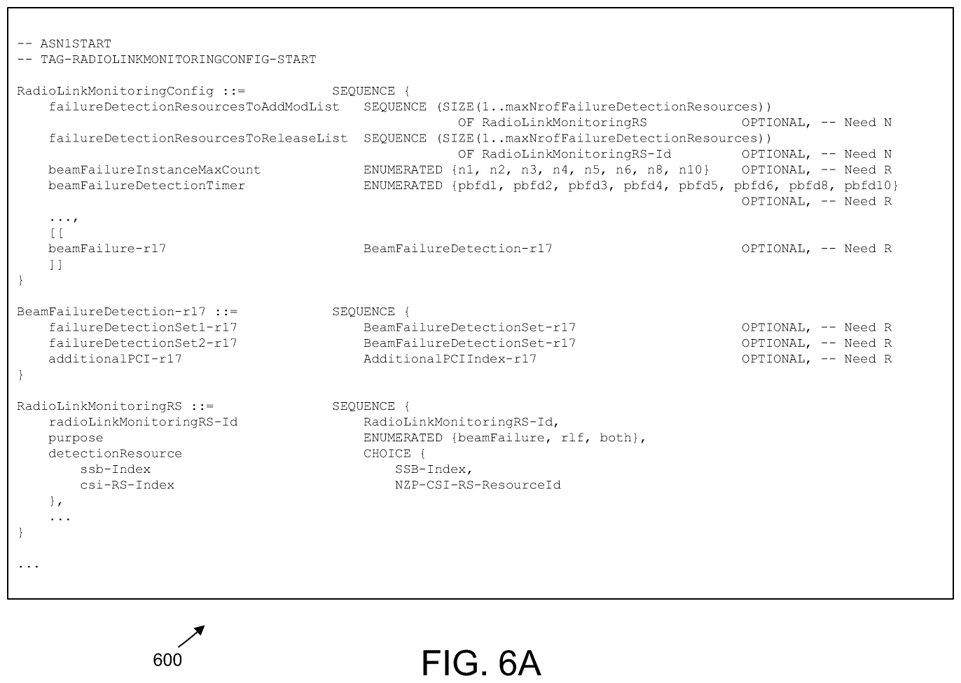

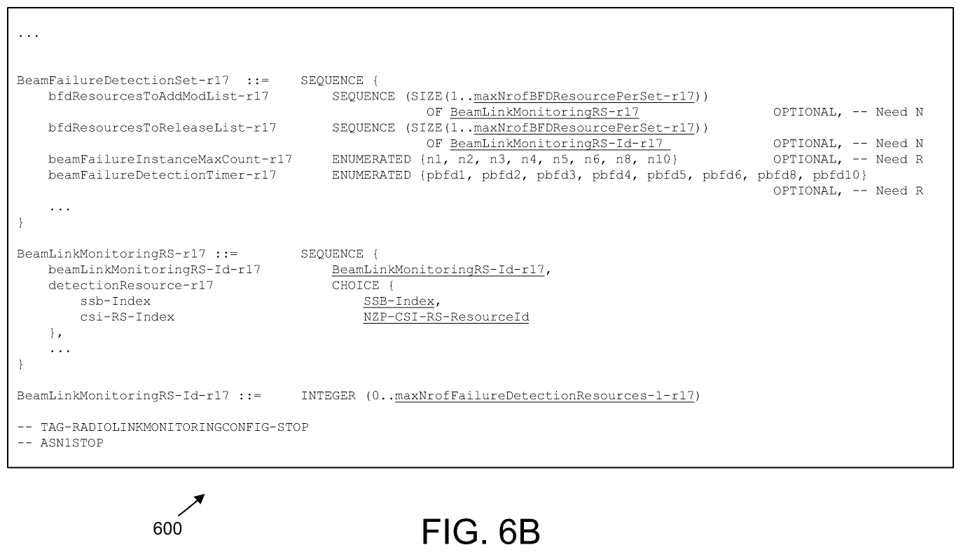

FIGS. 6A-6B illustrate an example of an ASN.1 representation of a radio link monitoring configuration 600, in accordance with aspects of the present disclosure. Note that the network may configure the CSI-RS as the reference signal resource for radio link monitoring purposes, as described in the seventh solution.

According to a further implementation, the “cell switch off” case can be supported using the “NES mode indication,” which offers flexibility to the network/operator. However, this can create issues with legacy operation due to the newly introduced “cell switch off.” For example, it may not be clear whether the SSB transmission, or SIB transmission, or PRACH reception is “ON” during cell switch off to cater to emergency calls, e.g., as mandated. Accordingly, the UE may need to know if it can (or should) perform RACH transmission to be able to trigger emergency calls, reestablishment, etc. To address these potential issues, the UE behaviors are described with reference to the following scenarios: Scenario A, where the UE receives the DCI before CHO condition(s) are satisfied, and Scenario B, where the DCI is received after the CHO condition(s) are satisfied.

In Scenario A, the UE has received NES CHO configuration and later also DCI 2_9 (i.e., with NES mode=enabled). At this point two different UE responses are:

According to a first response, the UE stops performing the cell measurements, assuming that the cell is going to sleep immediately. Since no handover target (i.e., a triggering cell fulfilling NES CHO condition) is available at this time, the UE will trigger an RLF condition.

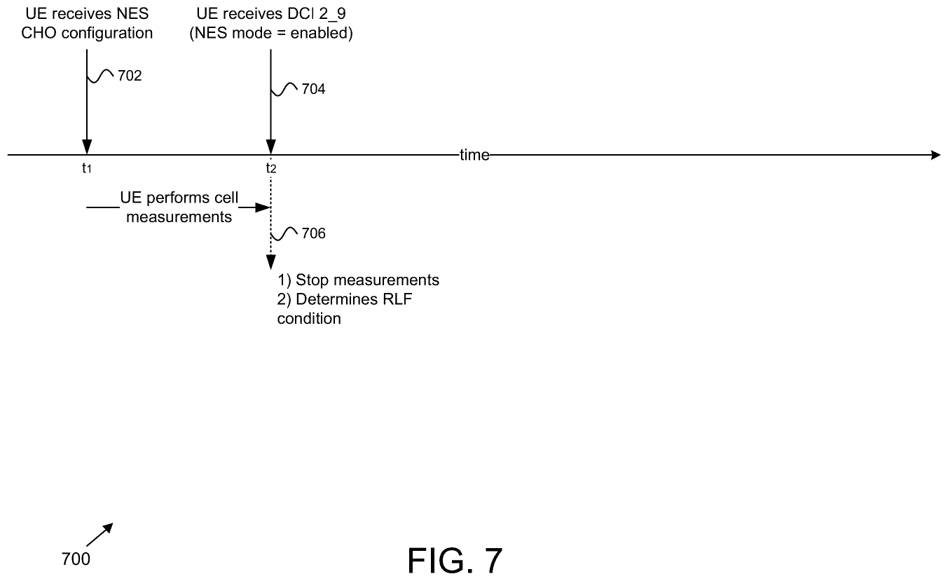

FIG. 7 illustrates an example of a timeline 700 corresponding to this first response to the Scenario A. The timeline 700 may implement or be implemented by aspects of the wireless communications system 100, or may implement or be implemented by aspects of the protocol stack 200. For example, the timeline 700 may be implemented between a gNB, which may be examples of a NE 102 and/or a RAN node 208 as described herein, and a UE, which may be examples of the UE 104 and/or UE 206.

As depicted in FIG. 7, at a first time (t₁) the UE receives a NES CHO configuration, which may include an NES mode indication as well as legacy CHO configuration parameters (see event 702). The UE starts measurements and evaluation (e.g., immediately upon receipt of the CHO configuration) and at a second time (t₂) the UE receives the DCI format 2_9 (see event 704). Because no handover target was selected when the DCI format 2_9 was received, the UE stops the cell measurements and triggers RLF (see event 706).

Alternatively, according to a second response to the Scenario A, the UE may continue performing cell measurements. If the UE finds a cell fulfilling the CHO condition(s), it will execute handover; else, the UE remains on the source cell.

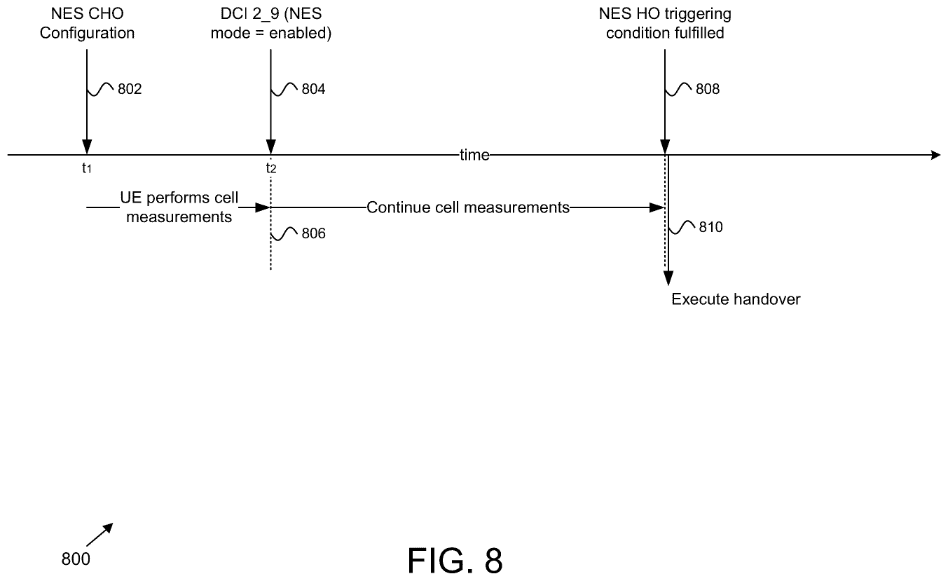

FIG. 8 illustrates an example of a timeline 800 corresponding to the second response to the Scenario A. The timeline 800 may implement or be implemented by aspects of the wireless communications system 100, or may implement or be implemented by aspects of the protocol stack 200. For example, the timeline 800 may be implemented between a gNB, which may be examples of a NE 102 and/or a RAN node 208 as described herein, and a UE, which may be examples of the UE 104 and/or UE 206.

As depicted in FIG. 8, at a first time (t₁) the UE receives a NES CHO configuration, which may include an NES mode indication as well as legacy CHO configuration parameters (see event 802). The UE starts measurements and evaluation (e.g., immediately upon receipt of the CHO configuration) and at a second time (t₂) the UE receives the DCI format 2_9 (see event 804). Because no handover target was selected when was received, the UE continues performing cell measurements after receiving the DCI format 2_9 (see event 806). If the UE finds a triggering cell that satisfies the handover conditions (see event 808), then it will execute handover (see event 810); else, the UE remains on the source cell.

However, if the source cell is using cell DTX/DRX, the UE may continue in the source cell (with a reduced QoS perhaps). But if the source cell is switched off, the UE would be in trouble if SSBs are transmitted, and RLM may not lead to RLF (hypothetical PDCCH BLER does not trigger the Out-of-Sync condition) but the UE cannot receive and/or transmit data—and may unnecessarily be performing SR and/or RACH transmissions.

As another possible response to the Scenario A, the UE may execute a handover to the best available candidate cell, even if this is not a triggering cell (i.e., a cell that satisfies the one or more CHO conditions).

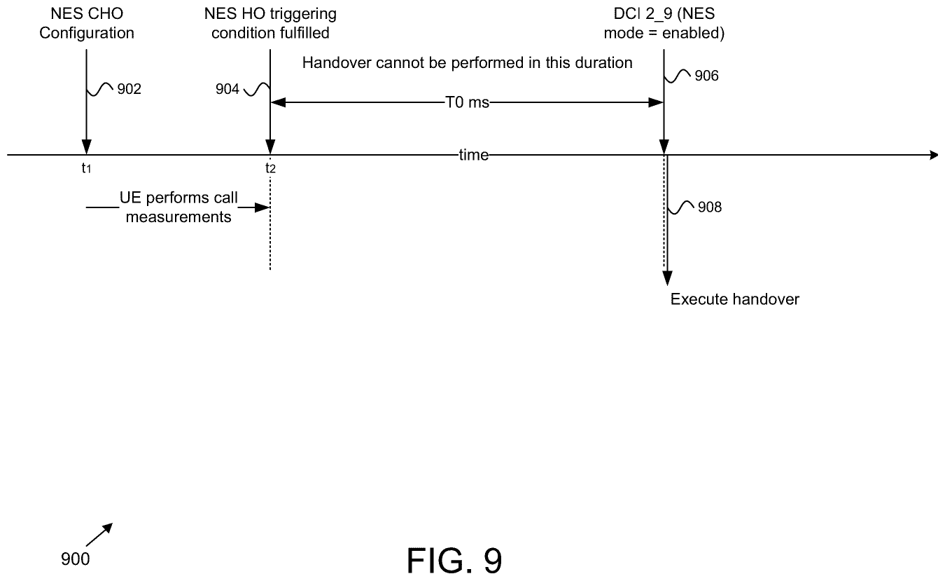

FIG. 9 illustrates an example of a timeline 900 corresponding to the Scenario B. The timeline 900 may implement or be implemented by aspects of the wireless communications system 100, or may implement or be implemented by aspects of the protocol stack 200. For example, the timeline 900 may be implemented between a gNB, which may be examples of a NE 102 and/or a RAN node 208 as described herein, and a UE, which may be examples of the UE 104 and/or UE 206.

As depicted in FIG. 9, at a first time (t₁) the UE receives a NES CHO configuration, which may include an NES mode indication as well as legacy CHO configuration parameters (see event 902). The UE starts measurements and evaluation (e.g., immediately upon receipt of the CHO configuration). In Scenario B, at a second time (t₂), the UE determines that a triggering cell (referred to as “C1”) is available (see event 904). However, in this scenario the DCI 2_9—including NES mode indication (enabled)—is received (see event 906), but the DCI 2_9 comes at a third time (t₃) much later after the CHO condition(s) was/were satisfied (depicted as an interval of T0 milliseconds), at which point the cell C1 may longer fulfill the NES CHO condition. Assuming that the UE does not “immediately” perform the CHO once triggering cell C1 becomes available, it is possible that no handover target is selected when the DCI format 2_9 is received. In such a situation, the UE would stop performing cell measurements and trigger a RLF condition.

However, in a first response to the Scenario B, the UE may proceed to execute handover to cell C1 when the DCI format 2_9 is received (see event 908). Alternatively, in a second response to the Scenario B, the UE may continue to perform cell measurements and may execute handover to a triggering cell (e.g., cell C1 or another cell) based on fresh measurements and evaluation. Note that the legacy behavior does not oblige the UE to perform measurements after a triggering cell is found.

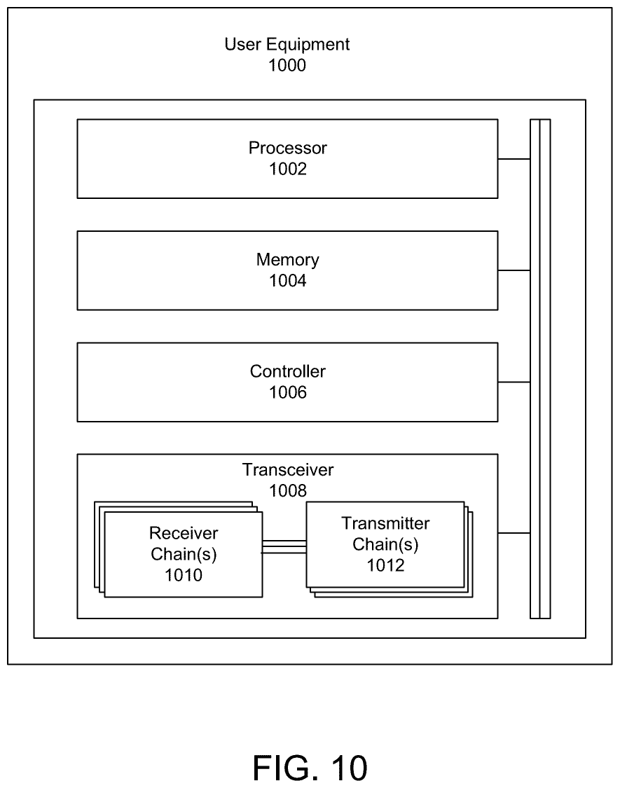

FIG. 10 illustrates an example of a UE 1000 in accordance with aspects of the present disclosure. The UE 1000 may include a processor 1002, a memory 1004, a controller 1006, and a transceiver 1008. The processor 1002, the memory 1004, the controller 1006, or the transceiver 1008, or various combinations thereof or various components thereof may be examples of means for performing various aspects of the present disclosure as described herein. These components may be coupled (e.g., operatively, communicatively, functionally, electronically, electrically) via one or more interfaces.

The processor 1002, the memory 1004, the controller 1006, or the transceiver 1008, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1002 may include an intelligent hardware device (e.g., a general-purpose processor, a DSP, a central processing unit (CPU), an ASIC, a field programmable gate array (FPGA), or any combination thereof). In some implementations, the processor 1002 may be configured to operate the memory 1004. In some other implementations, the memory 1004 may be integrated into the processor 1002. The processor 1002 may be configured to execute computer-readable instructions stored in the memory 1004 to cause the UE 1000 to perform various functions of the present disclosure.

The memory 1004 may include volatile or non-volatile memory. The memory 1004 may store computer-readable, computer-executable code including instructions that, when executed by the processor 1002, cause the UE 1000 to perform various functions described herein. The code may be stored in a non-transitory computer-readable medium such the memory 1004 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1002 and the memory 1004 coupled with the processor 1002 may be configured to cause the UE 1000 to perform various functions (e.g., operations, signaling) described herein (e.g., executing, by the processor 1002, instructions stored in the memory 1004). In some implementations, the processor 1002 may include multiple processors and the memory 1004 may include multiple memories. One or more of the multiple processors may be coupled with one or more of the multiple memories, which may be individually or collectively, configured to perform various functions (e.g., operations, signaling) of the UE 1000 as disclosed herein.

The processor 1002 coupled with the memory 1004 may be configured to, capable of, or operable to cause the UE 1000 to receive, e.g., from a serving cell of a radio network, a CHO configuration comprising at least one candidate radio cell and a corresponding condition for handover execution.

The processor 1002 coupled with the memory 1004 may be configured to, capable of, or operable to cause the UE 1000 to perform measurements of the at least one candidate radio cell and a means for determining if a first candidate radio cell satisfies the corresponding condition for handover execution.

The processor 1002 coupled with the memory 1004 may be configured to, capable of, or operable to cause the UE 1000 to start a first timer in response to initiating the handover execution to the first candidate radio cell and a means for determining that the handover execution has failed in response to expiry of the first timer. In some implementations, the first timer comprises a T304 timer used for detecting handover failure.

The processor 1002 coupled with the memory 1004 may be configured to, capable of, or operable to cause the UE 1000 to start a second timer and to start cell selection on one or more neighboring frequencies in response to determining that the handover execution has failed. In some implementations, the processor 1002 coupled with the memory 1004 may be configured to, capable of, or operable to cause the UE 1000 to receive broadcast signaling comprising assistance information that indicates the neighboring frequencies and at least one neighbor cell.

The processor 1002 coupled with the memory 1004 may be configured to, capable of, or operable to cause the UE 1000 to select a second candidate radio cell before expiry of the second timer and a means for transmitting a reestablishment request to the second candidate radio cell based on the second time being unexpired. In some implementations, the second timer comprises a T311 timer used for supervision of the cell selection procedure.

In some implementations, the processor 1002 coupled with the memory 1004 may be configured to, capable of, or operable to cause the UE 1000 to ignore a frequency layer associated with the serving cell during the cell selection in response to the failure of the handover execution.

In some implementations, the processor 1002 coupled with the memory 1004 may be configured to, capable of, or operable to cause the UE 1000 to: A) receive a DCI triggering the handover execution; and B) ignore a frequency layer associated with the serving cell during the cell selection in response to the failure of the handover execution and the DCI triggering the handover execution.

In some implementations, the processor 1002 coupled with the memory 1004 may be configured to, capable of, or operable to cause the UE 1000 to: A) determine that the serving cell is switched off after initiating the handover execution; and B) ignore a frequency layer associated with the serving cell during the cell selection in response to the failure of the handover execution and the DCI triggering the handover execution.

In certain implementations, the processor 1002 coupled with the memory 1004 may be configured to, capable of, or operable to cause the UE 1000 to: A) receive a switch-off indication from the serving cell; and B) determine that the serving cell is switched off based on the switch-off indication. In certain implementations, the processor 1002 coupled with the memory 1004 may be configured to, capable of, or operable to cause the UE 1000 to A) receive a configuration indicating cell discontinuous transmission and cell discontinuation reception; and B) determine that the serving cell is switched off based on the configuration.

The controller 1006 may manage input and output signals for the UE 1000. The controller 1006 may also manage peripherals not integrated into the UE 1000. In some implementations, the controller 1006 may utilize an operating system (OS) such as iOS®, ANDROID®, WINDOWS®, or other operating systems. In some implementations, the controller 1006 may be implemented as part of the processor 1002.

In some implementations, the UE 1000 may include at least one transceiver 1008. In some other implementations, the UE 1000 may have more than one transceiver 1008. The transceiver 1008 may represent a wireless transceiver. The transceiver 1008 may include one or more receiver chains 1010, one or more transmitter chains 1012, or a combination thereof.

A receiver chain 1010 may be configured to receive signals (e.g., control information, data, packets) over a wireless medium. For example, the receiver chain 1010 may include one or more antennas for receiving the signal over the air or wireless medium. The receiver chain 1010 may include at least one amplifier (e.g., a low-noise amplifier (LNA)) configured to amplify the received signal. The receiver chain 1010 may include at least one demodulator configured to demodulate the received signal and obtain the transmitted data by reversing the modulation technique applied during transmission of the signal. The receiver chain 1010 may include at least one decoder for decoding/processing the demodulated signal to receive the transmitted data.

A transmitter chain 1012 may be configured to generate and transmit signals (e.g., control information, data, packets). The transmitter chain 1012 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1012 may also include at least one power amplifier configured to amplify the modulated signal to an appropriate power level suitable for transmission over the wireless medium. The transmitter chain 1012 may also include one or more antennas for transmitting the amplified signal into the air or wireless medium.

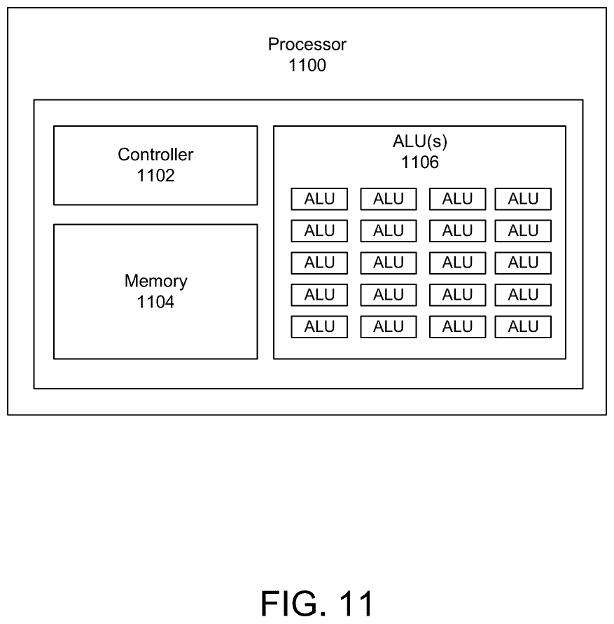

FIG. 11 illustrates an example of a processor 1100 in accordance with aspects of the present disclosure. The processor 1100 may be an example of a processor configured to perform various operations in accordance with examples as described herein. The processor 1100 may include a controller 1102 configured to perform various operations in accordance with examples as described herein. The processor 1100 may optionally include at least one memory 1104, which may be, for example, an L1/L2/L3 cache. Additionally, or alternatively, the processor 1100 may optionally include one or more arithmetic-logic units (ALUs) 1106. One or more of these components may be in electronic communication or otherwise coupled (e.g., operatively, communicatively, functionally, electronically, electrically) via one or more interfaces (e.g., buses).

The processor 1100 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 1100) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 1102 may be configured to manage and coordinate various operations (e.g., signaling, receiving, obtaining, retrieving, transmitting, outputting, forwarding, storing, determining, identifying, accessing, writing, reading) of the processor 1100 to cause the processor 1100 to support various operations in accordance with examples as described herein. For example, the controller 1102 may operate as a control unit of the processor 1100, generating control signals that manage the operation of various components of the processor 1100. These control signals include enabling or disabling functional units, selecting data paths, initiating memory access, and coordinating timing of operations.

The controller 1102 may be configured to fetch (e.g., obtain, retrieve, receive) instructions from the memory 1104 and determine subsequent instruction(s) to be executed to cause the processor 1100 to support various operations in accordance with examples as described herein. The controller 1102 may be configured to track memory address of instructions associated with the memory 1104. The controller 1102 may be configured to decode instructions to determine the operation to be performed and the operands involved. For example, the controller 1102 may be configured to interpret the instruction and determine control signals to be output to other components of the processor 1100 to cause the processor 1100 to support various operations in accordance with examples as described herein. Additionally, or alternatively, the controller 1102 may be configured to manage flow of data within the processor 1100. The controller 1102 may be configured to control transfer of data between registers, arithmetic logic units (ALUs), and other functional units of the processor 1100.

The memory 1104 may include one or more caches (e.g., memory local to or included in the processor 1100 or other memory, such RAM, ROM, DRAM, SDRAM, SRAM, MRAM, flash memory, etc. In some implementations, the memory 1104 may reside within or on a processor chipset (e.g., local to the processor 1100). In some other implementations, the memory 1104 may reside external to the processor chipset (e.g., remote to the processor 1100).

The memory 1104 may store computer-readable, computer-executable code including instructions that, when executed by the processor 1100, cause the processor 1100 to perform various functions described herein. The code may be stored in a non-transitory computer-readable medium such as system memory or another type of memory. The controller 1102 and/or the processor 1100 may be configured to execute computer-readable instructions stored in the memory 1104 to cause the processor 1100 to perform various functions. For example, the processor 1100 and/or the controller 1102 may be coupled with or to the memory 1104, the processor 1100, the controller 1102, and the memory 1104 may be configured to perform various functions described herein. In some examples, the processor 1100 may include multiple processors and the memory 1104 may include multiple memories. One or more of the multiple processors may be coupled with one or more of the multiple memories, which may, individually or collectively, be configured to perform various functions herein.

The one or more ALUs 1106 may be configured to support various operations in accordance with examples as described herein. In some implementations, the one or more ALUs 1106 may reside within or on a processor chipset (e.g., the processor 1100). In some other implementations, the one or more ALUs 1106 may reside external to the processor chipset (e.g., the processor 1100). One or more ALUs 1106 may perform one or more computations such as addition, subtraction, multiplication, and division on data. For example, one or more ALUs 1106 may receive input operands and an operation code, which determines an operation to be executed. One or more ALUs 1106 be configured with a variety of logical and arithmetic circuits, including adders, subtractors, shifters, and logic gates, to process and manipulate the data according to the operation. Additionally, or alternatively, the one or more ALUs 1106 may support logical operations such as AND, OR, exclusive-OR (XOR), not-OR (NOR), and not-AND (NAND), enabling the one or more ALUs 1106 to handle conditional operations, comparisons, and bitwise operations.

In some implementations, the processor 1100 may support various functions (e.g., operations, signaling) of a UE, in accordance with examples as disclosed herein. For example, the controller 1102 coupled with the memory 1104 may be configured to, capable of, or operable to cause the processor 1100 to receive, from a serving cell, a CHO configuration comprising at least one candidate radio cell and a corresponding condition for handover execution; start a first timer in response to initiating a handover execution to a first candidate radio cell; determine that the handover execution has failed in response to expiry of the first timer; start a second timer in response to determining that the handover execution has failed; and transmit a reestablishment request to a second candidate radio cell based on the second timer being unexpired. Additionally, the controller 1102 coupled with the memory 1104 may be configured to, capable of, or operable to cause the processor 1100 to perform one or more functions (e.g., operations, signaling) of the UE as described herein.

Additionally, or alternatively, in some other implementations, the processor 1100 may support various functions (e.g., operations, signaling) of a NE (e.g., base station), in accordance with examples as disclosed herein. For example, the controller 1102 coupled with the memory 1104 may be configured to, capable of, or operable to cause the processor 1100 to transmit, to a UE, a CHO configuration comprising at least one candidate radio cell and a corresponding condition for handover execution; transmit a configuration for a first timer and a second timer associated with the handover execution; and broadcast assistance information associated with a set of neighboring frequencies and at least one neighbor cell. Additionally, the controller 1102 coupled with the memory 1104 may be configured to, capable of, or operable to cause the processor 1100 to perform one or more functions (e.g., operations, signaling) of the NE as described herein.

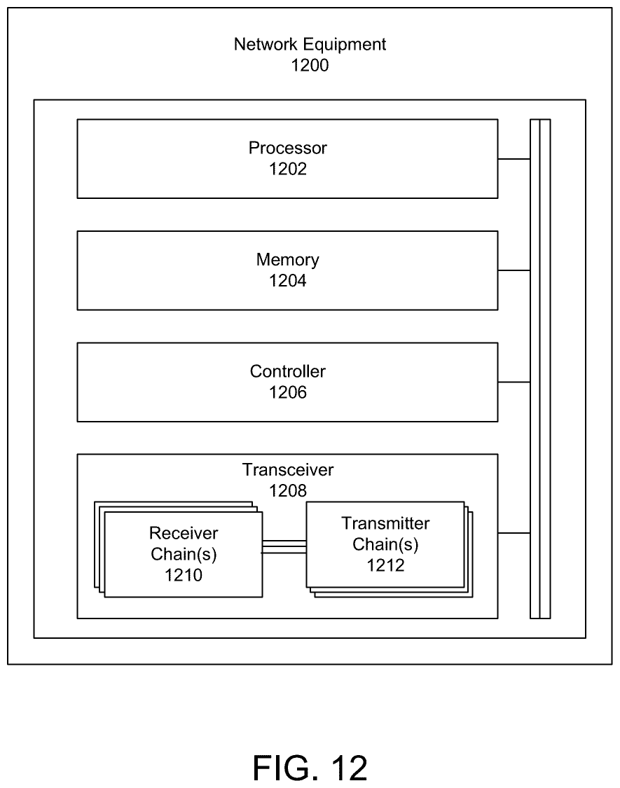

FIG. 12 illustrates an example of a NE 1200 in accordance with aspects of the present disclosure. The NE 1200 may include a processor 1202, a memory 1204, a controller 1206, and a transceiver 1208. The processor 1202, the memory 1204, the controller 1206, or the transceiver 1208, or various combinations thereof or various components thereof may be examples of means for performing various aspects of the present disclosure as described herein. These components may be coupled (e.g., operatively, communicatively, functionally, electronically, electrically) via one or more interfaces.

The processor 1202, the memory 1204, the controller 1206, or the transceiver 1208, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1202 may include an intelligent hardware device (e.g., a general-purpose processor, a DSP, a CPU, an ASIC, an FPGA, or any combination thereof). In some implementations, the processor 1202 may be configured to operate the memory 1204. In some other implementations, the memory 1204 may be integrated into the processor 1202. The processor 1202 may be configured to execute computer-readable instructions stored in the memory 1204 to cause the NE 1200 to perform various functions of the present disclosure.

The memory 1204 may include volatile or non-volatile memory. The memory 1204 may store computer-readable, computer-executable code including instructions when executed by the processor 1202 cause the NE 1200 to perform various functions described herein. The code may be stored in a non-transitory computer-readable medium such the memory 1204 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1202 and the memory 1204 coupled with the processor 1202 may be configured to cause the NE 1200 to perform various functions (e.g., operations, signaling) described herein (e.g., executing, by the processor 1202, instructions stored in the memory 1204). In some implementations, the processor 1202 may include multiple processors and the memory 1204 may include multiple memories. One or more of the multiple processors may be coupled with one or more of the multiple memories, which may be individually or collectively, configured to perform various functions (e.g., operations, signaling) of the NE 1200 as disclosed herein.

The processor 1202 coupled with the memory 1204 may be configured to, capable of, or operable to cause the NE 1200 to transmit to a UE (e.g., and from a serving cell of a radio network), a CHO configuration comprising at least one candidate radio cell and a corresponding condition for handover execution;

The processor 1202 coupled with the memory 1204 may be configured to, capable of, or operable to cause the NE 1200 to transmit a configuration for a first timer and a second timer associated with the handover execution. In some implementations, the first timer comprises a T304 timer used for detecting handover failure, and the second timer comprises a T311 timer used for supervision of the cell selection procedure.

The processor 1202 coupled with the memory 1204 may be configured to, capable of, or operable to cause the NE 1200 to broadcast assistance information that indicates a set of neighboring frequencies and at least one neighbor cell. In some implementations, the processor 1202 coupled with the memory 1204 may be configured to, capable of, or operable to cause the NE 1200 to establish a connection with the UE via a second radio cell.

In some implementations, the processor 1202 coupled with the memory 1204 may be configured to, capable of, or operable to cause the NE 1200 to transmit a DCI triggering the handover execution. In some implementations, the processor 1202 coupled with the memory 1204 may be configured to, capable of, or operable to cause the NE 1200 to transmit a switch-off indication to the UE. In some implementations, the processor 1202 coupled with the memory 1204 may be configured to, capable of, or operable to cause the NE 1200 to transmit a configuration indicating cell discontinuous transmission and cell discontinuation reception.

The controller 1206 may manage input and output signals for the NE 1200. The controller 1206 may also manage peripherals not integrated into the NE 1200. In some implementations, the controller 1206 may utilize an operating system such as iOS®, ANDROID®, WINDOWS®, or other operating systems. In some implementations, the controller 1206 may be implemented as part of the processor 1202.

In some implementations, the NE 1200 may include at least one transceiver 1208. In some other implementations, the NE 1200 may have more than one transceiver 1208. The transceiver 1208 may represent a wireless transceiver. The transceiver 1208 may include one or more receiver chains 1210, one or more transmitter chains 1212, or a combination thereof.

A receiver chain 1210 may be configured to receive signals (e.g., control information, data, packets) over a wireless medium. For example, the receiver chain 1210 may include one or more antennas for receiving the signal over the air or wireless medium. The receiver chain 1210 may include at least one amplifier (e.g., a low-noise amplifier (LNA)) configured to amplify the received signal. The receiver chain 1210 may include at least one demodulator configured to demodulate the received signal and obtain the transmitted data by reversing the modulation technique applied during transmission of the signal. The receiver chain 1210 may include at least one decoder for decoding/processing the demodulated signal to receive the transmitted data.

A transmitter chain 1212 may be configured to generate and transmit signals (e.g., control information, data, packets). The transmitter chain 1212 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1212 may also include at least one power amplifier configured to amplify the modulated signal to an appropriate power level suitable for transmission over the wireless medium. The transmitter chain 1212 may also include one or more antennas for transmitting the amplified signal into the air or wireless medium.

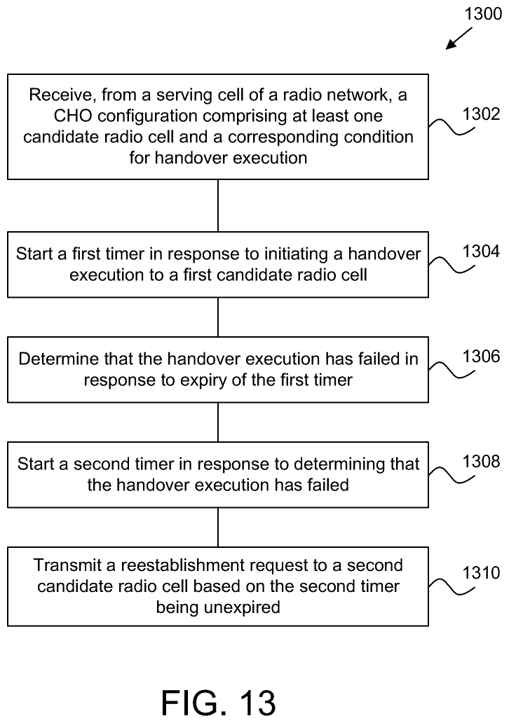

FIG. 13 illustrates an example of a method 1300 in accordance with aspects of the present disclosure. In various implementations, the operations of the method 1300 may be implemented by a UE as described herein. In some implementations, the UE may execute a set of instructions to control the function elements of the UE to perform the described functions.

At step 1302, the method 1300 may include receiving, from a serving cell, a CHO configuration comprising at least one candidate radio cell and a corresponding condition for handover execution. The operations of step 1302 may be performed in accordance with examples as described herein. In some implementations, aspects of the operation of step 1302 may be performed by a UE, as described with reference to FIG. 10.

At step 1304, the method 1300 may include starting a first timer in response to initiating a handover execution to a first candidate radio cell. The operations of step 1304 may be performed in accordance with examples as described herein. In some implementations, aspects of the operation of step 1304 may be performed by a UE, as described with reference to FIG. 10.

At step 1306, the method 1300 may include determining that the handover execution has failed in response to expiry of the first timer. The operations of step 1306 may be performed in accordance with examples as described herein. In some implementations, aspects of the operation of step 1306 may be performed by a UE, as described with reference to FIG. 10.

At step 1308, the method 1300 may include starting a second timer in response to determining that the handover execution has failed. The operations of step 1308 may be performed in accordance with examples as described herein. In some implementations, aspects of the operation of step 1308 may be performed by a UE, as described with reference to FIG. 10.

At step 1310, the method 1300 may include transmitting a reestablishment request to a second candidate radio cell based on the second timer being unexpired. The operations of step 1310 may be performed in accordance with examples as described herein. In some implementations, aspects of the operation of step 1310 may be performed by a UE, as described with reference to FIG. 10.

It should be noted that the method 1300 described herein describes one possible implementation, and that the operations and the steps may be rearranged or otherwise modified and that other implementations are possible.

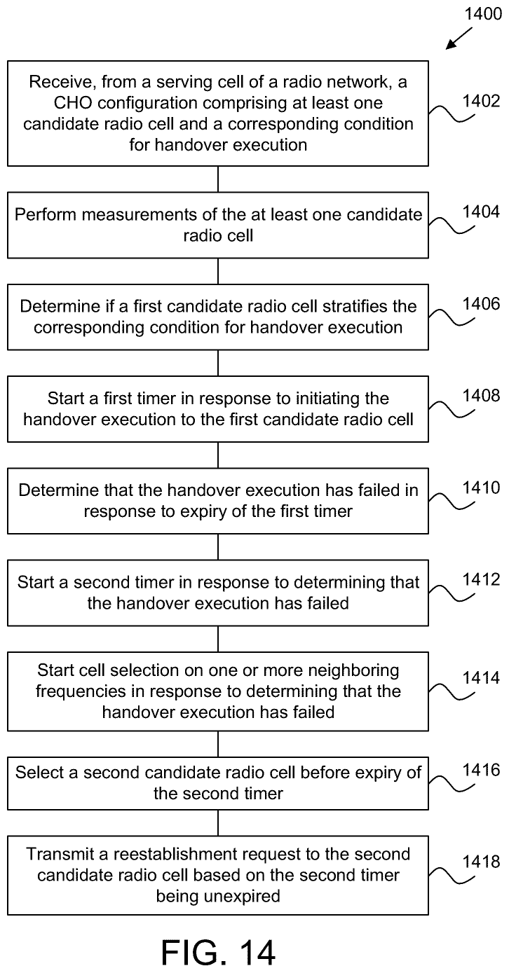

FIG. 14 illustrates an example of a method 1400 in accordance with aspects of the present disclosure. In various implementations, the operations of the method 1400 may be implemented by a UE as described herein. In some implementations, the UE may execute a set of instructions to control the function elements of the UE to perform the described functions.

At step 1402, the method 1400 may include receiving, from a serving cell, a CHO configuration comprising at least one candidate radio cell and a corresponding condition for handover execution. The operations of step 1402 may be performed in accordance with examples as described herein. In some implementations, aspects of the operation of step 1402 may be performed by a UE, as described with reference to FIG. 10.

At step 1404, the method 1400 may include performing measurements of the at least one candidate radio cell. The operations of step 1404 may be performed in accordance with examples as described herein. In some implementations, aspects of the operation of step 1404 may be performed by a UE, as described with reference to FIG. 10.

At step 1406, the method 1400 may include determining if a first candidate radio cell satisfies the corresponding condition for handover execution. The operations of step 1406 may be performed in accordance with examples as described herein. In some implementations, aspects of the operation of step 1406 may be performed by a UE, as described with reference to FIG. 10.

At step 1408, the method 1400 may include starting a first timer in response to initiating the handover execution to the first candidate radio cell. The operations of step 1408 may be performed in accordance with examples as described herein. In some implementations, aspects of the operation of step 1408 may be performed by a UE, as described with reference to FIG. 10.

At step 1410, the method 1400 may include determining that the handover execution has failed in response to expiry of the first timer. The operations of step 1410 may be performed in accordance with examples as described herein. In some implementations, aspects of the operation of step 1410 may be performed by a UE, as described with reference to FIG. 10.

At step 1412, the method 1400 may include starting a second timer in response to determining that the handover execution has failed. The operations of step 1412 may be performed in accordance with examples as described herein. In some implementations, aspects of the operation of step 1412 may be performed by a UE, as described with reference to FIG. 10.

At step 1414, the method 1400 may include starting cell selection on one or more neighboring frequencies in response to determining that the handover execution has failed. The operations of step 1414 may be performed in accordance with examples as described herein. In some implementations, aspects of the operation of step 1414 may be performed by a UE, as described with reference to FIG. 10.

At step 1416, the method 1400 may include selecting a second candidate radio cell before expiry of the second timer. The operations of step 1416 may be performed in accordance with examples as described herein. In some implementations, aspects of the operation of step 1416 may be performed by a UE, as described with reference to FIG. 10.

At step 1418, the method 1400 may include transmitting a reestablishment request to the second candidate radio cell based on the second timer being unexpired. The operations of step 1418 may be performed in accordance with examples as described herein. In some implementations, aspects of the operation of step 1418 may be performed by a UE, as described with reference to FIG. 10.

It should be noted that the method 1400 described herein describes one possible implementation, and that the operations and the steps may be rearranged or otherwise modified and that other implementations are possible.

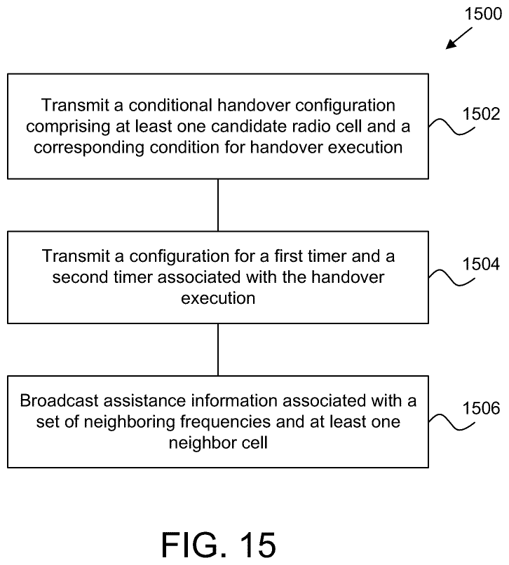

FIG. 15 illustrates an example of a method 1500 in accordance with aspects of the present disclosure. The operations of the method 1500 may be implemented by a RAN as described herein. In some implementations, the RAN may execute a set of instructions to control the function elements of the RAN to perform the described functions.

At step 1502, the method 1500 may include transmitting, to a user equipment (UE), a CHO configuration comprising at least one candidate radio cell and a corresponding condition for handover execution. The operations of step 1502 may be performed in accordance with examples as described herein. In some implementations, aspects of the operations of step 1502 may be performed by a NE, as described with reference to FIG. 12.

At step 1504, the method 1500 may include transmitting a configuration for a first timer and a second timer associated with the handover execution. The operations of step 1404 may be performed in accordance with examples as described herein. In some implementations, aspects of the operations of step 1504 may be performed by a NE, as described with reference to FIG. 12.

At step 1506, the method 1500 may include broadcasting assistance information associated with a set of neighboring frequencies and at least one neighbor cell. The operations of step 1506 may be performed in accordance with examples as described herein. In some implementations, aspects of the operations of step 1506 may be performed by a NE, as described with reference to FIG. 12.

It should be noted that the method 1500 described herein describes one possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and configured to cause the UE to:
receive, from a serving cell, a conditional handover configuration comprising at least one candidate radio cell and a corresponding condition for handover execution;
start a first timer in response to initiating a handover execution to a first candidate radio cell;
determine that the handover execution has failed in response to expiry of the first timer;
start a second timer in response to determining that the handover execution has failed; and
transmit a reestablishment request to a second candidate radio cell based on the second timer being unexpired.

2. The UE of claim 1, wherein the first timer comprises a T304 timer used for detecting handover failure, and wherein the second timer comprises a T311 timer used for supervision of a cell selection procedure.

3. The UE of claim 1, wherein the at least one processor is configured to cause the UE to:
receive broadcast signaling comprising assistance information indicating a set of neighboring frequencies and at least one neighbor cell;
initiate a cell selection procedure on the set of neighboring frequencies in response to determining that the handover execution has failed; and
select the second candidate radio cell based on the cell selection procedure.

4. The UE of claim 3, wherein the at least one processor is configured to cause the UE to ignore a frequency layer associated with the serving cell during the cell selection procedure in response to determining that the handover execution has failed.

5. The UE of claim 1, wherein the at least one processor is configured to cause the UE to:
receive a downlink control information (DCI) triggering the handover execution; and
ignore a frequency layer associated with the serving cell during a cell selection procedure in response to the failure of the handover execution and based on the DCI triggering the handover execution.

6. The UE of claim 1, wherein the at least one processor is configured to cause the UE to:
determine that the serving cell is switched off after initiating the handover execution; and
ignore a frequency layer associated with the serving cell during a cell selection procedure in response to determining that the handover execution has failed and based on downlink control information (DCI) triggering the handover execution.

7. The UE of claim 6, wherein the at least one processor is configured to cause the UE to:
receive a switch-off indication from the serving cell; and
determine that the serving cell is switched off based on the switch-off indication.

8. The UE of claim 6, wherein the at least one processor is configured to cause the UE to:
receive a configuration indicating cell discontinuous transmission and cell discontinuation reception; and
determine that the serving cell is switched off based on the configuration.

9. A method performed by a user equipment (UE), the method comprising:
receiving, from a serving cell, a conditional handover configuration comprising at least one candidate radio cell and a corresponding condition for handover execution;
starting a first timer in response to initiating the handover execution to a first candidate radio cell;
determining that the handover execution has failed in response to expiry of the first timer;
starting a second timer in response to determining that the handover execution has failed; and
transmitting a reestablishment request to a second candidate radio cell based on the second timer being unexpired.

10. The method of claim 9, wherein the first timer comprises a T304 timer used for detecting handover failure, and wherein the second timer comprises a T311 timer used for supervision of a cell selection procedure.

11. A base station for wireless communication, comprising:
at least one memory; and
at least one processor coupled with the at least one memory and configured to cause the base station to:
transmit, to a user equipment (UE), a conditional handover configuration comprising at least one candidate radio cell and a corresponding condition for handover execution;
transmit a configuration for a first timer and a second timer associated with the handover execution; and
broadcast assistance information associated with a set of neighboring frequencies and at least one neighbor cell.

12. The base station of claim 11, wherein the first timer comprises a T304 timer used for detecting handover failure, and wherein the second timer comprises a T311 timer used for supervision of a cell selection procedure.

13. The base station of claim 11, wherein the at least one processor is configured to cause the base station to transmit a downlink control information (DCI) triggering the handover execution.

14. The base station of claim 11, wherein the at least one processor is configured to cause the base station to transmit a switch-off indication to the UE.

15. The base station of claim 11, wherein the at least one processor is configured to cause the base station to transmit a configuration indicating cell discontinuous transmission and cell discontinuation reception.

16. A method performed by a base station, the method comprising:
transmitting, to a user equipment (UE), a conditional handover configuration comprising at least one candidate radio cell and a corresponding condition for handover execution;
transmitting a configuration for a first timer and a second timer associated with the handover execution; and
broadcasting assistance information that indicates a set of neighboring frequencies and at least one neighbor cell.

17. The method of claim 16, wherein the first timer comprises a T304 timer used for detecting handover failure, and wherein the second timer comprises a T311 timer used for supervision of a cell selection procedure.

18. The method of claim 16, further comprising transmitting a downlink control information (DCI) triggering the handover execution.

19. The method of claim 16, further comprising transmitting a switch-off indication to the UE.

20. The method of claim 16, further comprising transmitting a configuration indicating cell discontinuous transmission and cell discontinuation reception.
